(19) United States
(12) Patent Application Publication
(10) Pub. No.: US 2015/0304401 A1
(43) Pub. Date: Oct. 22, 2015

(54) DATA COMMUNICATION METHOD AND DATA COMMUNICATION SYSTEM

(71) Applicant: Kimree Hi-Tech Inc., Tortola (GB)

(72) Inventor: Qiuming LIU, Huizhou (CN)

(21) Appl. No.: 14/694,551

(22) Filed: Apr. 23, 2015

Related U.S. Application Data
(63) Continuation of application No. PCT/CN2014/075780, filed on Apr. 21, 2014.

(51) Int. Cl. H04L 29/08; H04L 29/06; A24F 47/00

(52) U.S. Cl. CPC H04L 67/10; A24F 47/008; H04L 67/42

(57) ABSTRACT

A data communication method and a data communication system are provided. The data communication method includes: detecting, by an electronic cigarette, a behavior characteristic of a user; generating, by the electronic cigarette, a triggering signal if the behavior characteristic of the user meets a reporting condition, where the triggering signal indicates a current behavior of the user; transmitting, by the electronic cigarette, the triggering signal to a user terminal bound to the electronic cigarette; analyzing, by the user terminal, the triggering signal to obtain an analysis result; transmitting, by the user terminal, a request massage to a service platform based on the analysis result; and pushing, by the service platform, corresponding information to the user terminal according to the request massage.

The present application is a continuation application of International Application No. PCT/CN2014/075780, titled “DATA COMMUNICATION METHOD AND DATA COMMUNICATION SYSTEM”, filed on Apr. 21, 2014, which is incorporated herein by reference in its entirety.

### FIELD

The present disclosure relates to the technical field of communication, and in particular, to a data communication method and a data communication system.

### BACKGROUND

The electronic cigarette is an innovative electronic product, which has an appearance and smell similar to those of a conventional tobacco cigarette, but is healthier and more environmentally protective than the conventional tobacco cigarette.

As the number of users of the electronic cigarettes increases, more demands on the function of the electronic cigarette are made by the users. An intelligent electronic cigarette is disclosed in the Chinese application No. 201310684449.X. The intelligent electronic cigarette includes a wireless communication module and a control module. The control module may encode smoking parameters into a smoking parameter file in compliance with a wireless communication protocol, decode the smoking parameter file into a smoking parameter signal, and transmit the smoking parameter signal to an intelligent terminal via the wireless communication module, thereby enabling a real-time or regular interaction between the electronic cigarette and the intelligent terminal.

In the above technology, although interaction is enabled between the user and the electronic cigarette, the interaction is limited to acquiring a smoking situation by the user, while the interaction of more other types of information cannot be achieved.

### SUMMARY

According to embodiments of the present disclosure, a data communication method and a data communication system are provided, with which the interaction of more other types of information can be achieved.

A data communication method according to an embodiment of the present disclosure includes:

detecting, by an electronic cigarette, a behavior characteristic of a user;

generating, by the electronic cigarette, a triggering signal if the behavior characteristic of the user meets a reporting condition, where the triggering signal indicates a current behavior of the user;

transmitting, by the electronic cigarette, the triggering signal to a user terminal bound to the electronic cigarette;

analyzing, by the user terminal, the triggering signal to obtain an analysis result;

transmitting, by the user terminal, a request massage to a service platform based on the analysis result; and

pushing, by the service platform, corresponding information to the user terminal according to the request massage.

Optionally, the method may further include:

establishing, by the electronic cigarette, a correlation between the electronic cigarette and the user terminal.

Optionally, the correlation between the electronic cigarette and the user terminal may be established by the electronic cigarette through a Bluetooth connection, a WIFI connection, an infrared connection or an NFC connection.

Optionally, the method may further include:

determining, by the electronic cigarette, whether the user is smoking with the electronic cigarette; and

determining that the behavior characteristic of the user meets the reporting condition, if the user is smoking with the electronic cigarette.

Optionally, the generating, by the electronic cigarette, the triggering signal may include:

generating a pulse signal and transmitting the pulse signal to a processor in the electronic cigarette, by a sensor in the electronic cigarette; and

generating, by the processor in the electronic cigarette, the triggering signal based on the pulse signal, where the triggering signal indicates that the user is smoking the electronic cigarette.

Optionally, the sensor may be an airflow sensitive switch or a key switch;

where the key switch may be a tact switch or a sensitive switch.

Optionally, the analyzing, by the user terminal, the triggering signal to obtain an analysis result may include:

determining, by the user terminal, whether the user has an interaction permission based on the triggering signal, and determining that the analysis result is that a transmission is permitted if the user has the interaction permission; and

the transmitting, by the user terminal, the request massage to the service platform based on the analysis result may include:

transmitting, by the user terminal, the request massage to the service platform if the analysis result is that the transmission is permitted.

Optionally, the determining, by the user terminal, whether the user has an interaction permission based on the triggering signal may include:

determining, by the user terminal, whether a smoking frequency of the user reaches a preset value based on the triggering signal; and determining that the user has the interaction permission if the smoking frequency of the user reaches the preset value.

Optionally, the pushing, by the service platform, the corresponding information to the user terminal according to the request massage may include:

pushing, by the service platform, advertising information or news contents to the user terminal.

Optionally, the pushing, by the service platform, the corresponding information to the user terminal according to the request massage may include:

determining whether users of multiple user terminals meet an interaction condition, by the service platform on reception of request massages of the multiple user terminals; and

pushing, by the service platform, interaction information to user terminals of users meeting the interaction condition, where the users meeting the interaction condition interact with each other.

Optionally, the determining whether users of multiple user terminals meet an interaction condition, by the service platform may include:

determining, by the service platform, whether distances between the users of the multiple user terminals are smaller than a preset distance; and

determining that the users of the multiple user terminals meet the interaction condition, if the distances between the users of the multiple user terminals are smaller than the preset distance.

Optionally, the user terminal may be a mobile phone, a personal computer, a laptop or a tablet computer.

A data communication system according to an embodiment of the present disclosure, includes:

an electronic cigarette, a user terminal and a service platform;

where the electronic cigarette is configured to, detect a behavior characteristic of a user, generate a triggering signal if the behavior characteristic of the user meets a reporting condition, and transmit the triggering signal to the user terminal bound to the electronic cigarette, the triggering signal indicating a current behavior of the user;

the user terminal is configured to analyze the triggering signal to obtain an analysis result and transmit a request massage to the service platform based on the analysis result; and

the service platform is configured to push corresponding information to the user terminal according to the request massage.

Optionally, a correlation between the electronic cigarette and the user terminal may be established by the electronic cigarette through a Bluetooth connection, a WIFI connection, an infrared connection or an NFC connection.

Optionally, the electronic cigarette at least may include a sensor and a processor;

where the sensor may be configured to generate a pulse signal and transmit the pulse signal to the processor in the electronic cigarette, when the user is smoking; and

the processor in the electronic cigarette is configured to generate the triggering signal based on the pulse signal, the triggering signal indicating that the user is smoking with the electronic cigarette.

Optionally, the sensor may be an airflow sensitive switch or a key switch; and

where the key switch may be a tact switch or a sensitive switch.

Optionally, the user terminal may be configured to, determine whether the user has an interaction permission based on the triggering signal, determine that the analysis result is that a transmission is permitted if the user has the interaction permission, and transmit the request message to the service platform if the analysis result is that the transmission is permitted.

Optionally, the user terminal may be a mobile phone, a personal computer, a laptop or a tablet computer.

It can be seen from the above technical solutions that the embodiments of the present disclosure have the following advantages.

In the embodiments of the present disclosure, when the behavior characteristic of the user meets the reporting condition, the triggering signal may be transmitted by the electronic cigarette to the user terminal for analysis, the request message may be transmitted by the user terminal to the service platform based on the analysis result, and the corresponding information may be pushed to the user terminal by the service platform according to the request message. Since different information may be pushed by the service platform according to different request messages, the content that the user may obtain is not limited to his or her smoking situation, and the user may obtain more contents from the service platform via the user terminal. Therefore, the interaction of more kinds of information can be realized and the user experience can be enhanced.

### BRIEF DESCRIPTION OF THE DRAWINGS

In order to illustrate technical solutions according to embodiments of the present disclosure or conventional technologies more clearly, drawings to be used in the description of the conventional technologies or the embodiments are described briefly hereinafter. Apparently, the drawings described hereinafter are only for some embodiments of the present disclosure, and other drawings may be obtained by those skilled in the art based on those drawings without creative labor.

FIG. 1 is a schematic diagram of a data communication method according to an embodiment of the present disclosure;

FIG. 2 is a schematic diagram of a data communication method according to another embodiment of the present disclosure;

FIG. 3 is a schematic diagram of a data communication method according to yet another embodiment of the present disclosure;

FIG. 4 is a schematic diagram of a data communication framework provided in the present disclosure; and

FIG. 5 is a schematic diagram of a data communication system according to an embodiment of the present disclosure.

### DETAILED DESCRIPTION OF THE EMBODIMENTS

Technical solutions in embodiments of the present application are described clearly and completely hereinafter in conjunction with drawings in the embodiments of the present application. Apparently, the described embodiments are only a part of but not all of the embodiments of the present application. All other embodiments obtained by those skilled in the art on the basis of the embodiments of the present application without creative efforts fall within the scope of protection of the present application.

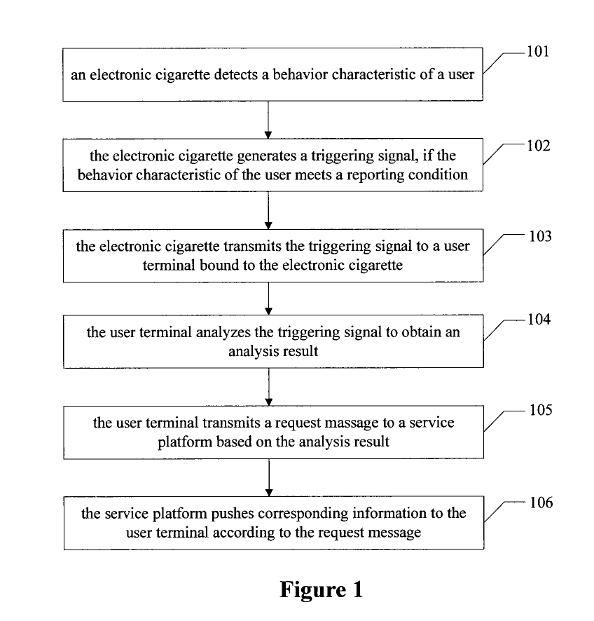

Reference is made to FIG. 1. A data communication method according to an embodiment of the present application includes steps 101 to 106.

In step 101, an electronic cigarette detects a behavior characteristic of a user.

In the embodiment, the electronic cigarette may detect the behavior characteristic of the user, to analyze a current behavior of the user, for example, the user is smoking, the user is going to smoke, or the user turns off the electronic cigarette, which is not limited in detail here.

In step 102, a triggering signal is generated by the electronic cigarette, if the behavior characteristic of the user meets a reporting condition.

A triggering signal may be generated by the electronic cigarette if the behavior characteristic of the user meets the reporting condition. The triggering signal is used to indicate a current behavior of the user, for example, the user is smoking, the user is going to smoke, or the user turns off the electronic cigarette, which is not limited in detail here.

In step 103, the triggering signal is transmitted by the electronic cigarette to a user terminal bound to the electronic cigarette.

After generating the triggering signal, the electronic cigarette may transmit the triggering signal to a user terminal which is bound to the electronic cigarette in advance.

In step 104, the triggering signal is analyzed by the user terminal to obtain an analysis result.

The user terminal analyzes, on reception of the triggering signal transmitted from the electronic cigarette, the triggering signal to obtain the analysis result.

It should be noted that, the analysis procedure may include operations such as learning a meaning indicated by the triggering signal, parsing a smoking parameter included in the triggering signal, performing a verification on the smoking parameter, and so on, which are not limited in detail here.

In step 105, a request massage is transmitted to a service platform by the user terminal based on the analysis result.

After the triggering signal is analyzed by the user terminal and the analysis result is obtained, the request message may be transmitted by the user terminal to the service platform based on the analysis result, where the request message is used to request the service platform to feed back information corresponding to the request message.

In step 106, corresponding information is pushed by the service platform to the user terminal according to the request message.

In the embodiment, corresponding information may be pushed to the user terminal by the service platform according to the request message transmitted by the user terminal.

In the embodiment, in the case that the behavior characteristic of the user meets the reporting condition, the triggering signal may be transmitted by the electronic cigarette to the user terminal for analysis, the request message may be transmitted by the user terminal to the service platform based on the analysis result, and the corresponding information may be pushed to the user terminal by the service platform according to the request message. Since different information may be pushed by the service platform according to different request messages, the content that the user may obtain is not limited to a smoking situation of the user, and more contents can be obtained from the service platform via the user terminal. Therefore, the interaction of more kinds of information can be realized and the user experience can be enhanced.

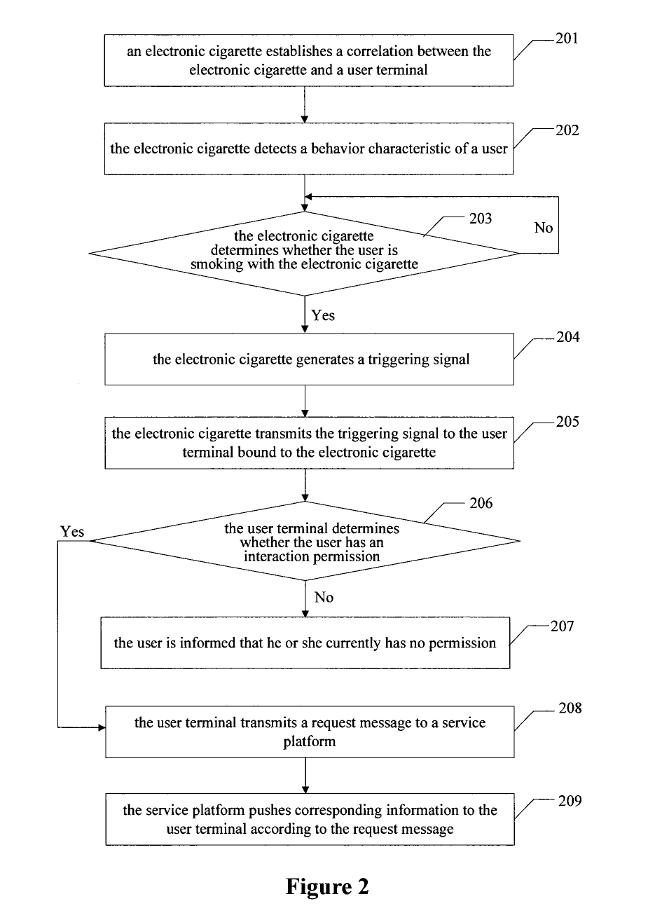

A data communication method according to an embodiment of the present application is described in detail in the following. Reference is made to FIG. 2. A data communication method according to another embodiment of the present application includes steps 201 to 209.

In step 201, a correlation between an electronic cigarette and a user terminal is established by the electronic cigarette.

In the embodiment, a user may bind his or her electronic cigarette to his or her user terminal. Particularly, the correlation between the electronic cigarette and the user terminal may be established by the electronic cigarette through a Bluetooth connection, a WIFI connection, an infrared connection or an NFC connection.

The user terminal in the embodiment may be a mobile phone, a personal computer, a laptop, a tablet computer, or other types of terminals, which is not limited in detail here.

In step 202, the electronic cigarette detects a behavior characteristic of the user.

In the embodiment, the behavior characteristic of the user may be detected by the electronic cigarette, to analyze a current behavior of the user, for example, the user is smoking, the user is going to smoke, or the user turns off the electronic cigarette, which is not limited in detail here.

In step 203, the electronic cigarette determines whether the user is smoking with the electronic cigarette; if the user is smoking with the electronic cigarette, step 204 is to be performed; or if the user is not smoking with the electronic cigarette, step 203 is to be repeated.

In the embodiment, after detecting the behavior characteristic of the user, the electronic cigarette may determine whether the user is smoking with the electronic cigarette; if the user is smoking with the electronic cigarette, step 204 is to be performed; or if the user is not smoking with the electronic cigarette, the determination is to be repeated.

It should be noted that whether the user is smoking with the electronic cigarette may be determined by the electronic cigarette in many manners. For example, the determination may be performed based on an operating condition of an atomizer assembly in the electronic cigarette, and when the atomizer assembly operates, it may be determined that the user is smoking with the electronic cigarette.

Alternatively, the determination may be performed based on an operating condition of a sensor in the electronic cigarette, and when the sensor operates, it may be determined that the user is smoking with the electronic cigarette.

Alternatively, the determination may be performed based on a consumption rate of a battery in the electronic cigarette, and when the battery consumption rate is larger than a threshold, it may be determined that the user is smoking with the electronic cigarette.

The sensor in the embodiment may be an airflow sensitive switch, a key switch, or other types of switches, which is not limited in detail here. The key switch may be a tact switch, a sensitive switch or other types of switches, which is neither limited in detail here.

It should be understood that whether the user is smoking with the electronic cigarette may be determined by the electronic cigarette in many other manners in practice, which are not limited in detail here.

In step 204, a triggering signal is generated by the electronic cigarette.

If the electronic cigarette detects that the user is smoking with the electronic cigarette, it may be determined that the behavior characteristic of the user meets a reporting condition, and the triggering signal may be generated by the electronic cigarette. The triggering signal is for indicating that the user is smoking with the electronic cigarette.

Particularly, the sensor in the electronic cigarette generates a pulse signal and transmits the pulse signal to a processor in the electronic cigarette; and

the triggering signal is generated by the processor in the electronic cigarette based on the pulse signal, where the triggering signal is for indicating that the user is smoking with the electronic cigarette.

In step 205, the triggering signal is transmitted by the electronic cigarette to the user terminal bound to the electronic cigarette.

After generating the triggering signal, the electronic cigarette may transmit the triggering signal to a user terminal which is bound to the electronic cigarette in advance.

In step 206, the user terminal determines whether the user has an interaction permission; if the user has the interaction permission, step 208 is to be performed; or if the user does not have the interaction permission, step 207 is to be performed.

In the embodiment, on reception of the triggering signal from the electronic cigarette, the user terminal may analyze the triggering signal to obtain an analysis result. The analysis procedure may include: determining whether the user has the interaction permission; determining that the analysis result is that a transmission is permitted, if the user has the interaction permission; or determining that the analysis result is that the transmission is not permitted, if the user does not have the interaction permission.

Particularly, the user terminal may determine whether a smoking frequency of the user reaches a preset value; if the smoking frequency of the user reaches the preset value, it indicates that the user is an active user of the electronic cigarette, and the user is determined as having the interaction permission; or if the smoking frequency of the user does not reach the preset value, it indicates that the user is a test user or an inactive user and the user is determined as having no interaction permission.

It should be understood that in addition to based on the smoking frequency of the user, whether the user has the interaction permission may be determined by the user terminal in other manners in practice, such as based on a frequency in which the user replaces cigarette liquid, which are not limited in detail here as long as the active user of the electronic cigarette has the interaction permission while the inactive user has no interaction permission.

It should be noted that the smoking frequency of the user, the frequency in which the user replaces the cigarette liquid and the like in the embodiment are all smoking parameters, and these smoking parameters may be synchronized into the user terminal in real time or periodically after the electronic cigarette is bound to the user terminal.

In step 207, the user is informed that he or she currently has no permission.

In the present embodiment, if the analysis result is that the transmission is not permitted, the user may be informed that he or she currently has no permission. The user may be further informed how to obtain the interaction permission, which is not limited in detail here.

In step 208, a request message is transmitted to a service platform by the user terminal.

In the present embodiment, if the analysis result is that the transmission is permitted, the request message may be generated and transmitted to the service platform, where the request message is used to request the service platform to transmit corresponding information to the user terminal.

Particularly, the request message may be transmitted to the service platform by the user terminal via a mobile communication network, a WIFI network, or other types of communication networks.

In step 209, corresponding information is pushed to the user terminal by the service platform according to the request message.

In the embodiment, advertising information or news content, including information about an electronic cigarette store nearby, knowledge of electronic cigarette maintenance and the like, may be pushed to the user terminal by the service platform in form of text, image, sound or video.

It should be noted that in the embodiment, if an APP program corresponding to the electronic cigarette is installed on the user terminal, information may be pushed to the APP program by the service platform and the information is presented to the user by the APP program; or if the APP program is not installed on the user terminal, the information may be pushed by the service platform to other programs (for example, a browser) originally installed on the user terminal and the information may be presented by these programs, which is not limited in detail here.

In the embodiment, in the case that the behavior characteristic of the user meets the reporting condition, the triggering signal may be transmitted by the electronic cigarette to the user terminal for analysis, the request message may be transmitted by the user terminal to the service platform based on the analysis result, and the corresponding information may be pushed to the user terminal by the service platform according to the request message. Since different information may be pushed by the service platform according to different request messages, the content that the user may obtain is not limited to his or her smoking situation, and the user may obtain more contents from the service platform via the user terminal. Therefore, the interaction of more kinds of information can be realized and the user experience can be enhanced.

Furthermore, on reception of the triggering signal from the electronic cigarette, the user terminal may detect the interaction permission of the user, and the information pushed by the service platform can be received only by the user having the interaction permission, thereby reducing the burden on the service platform.

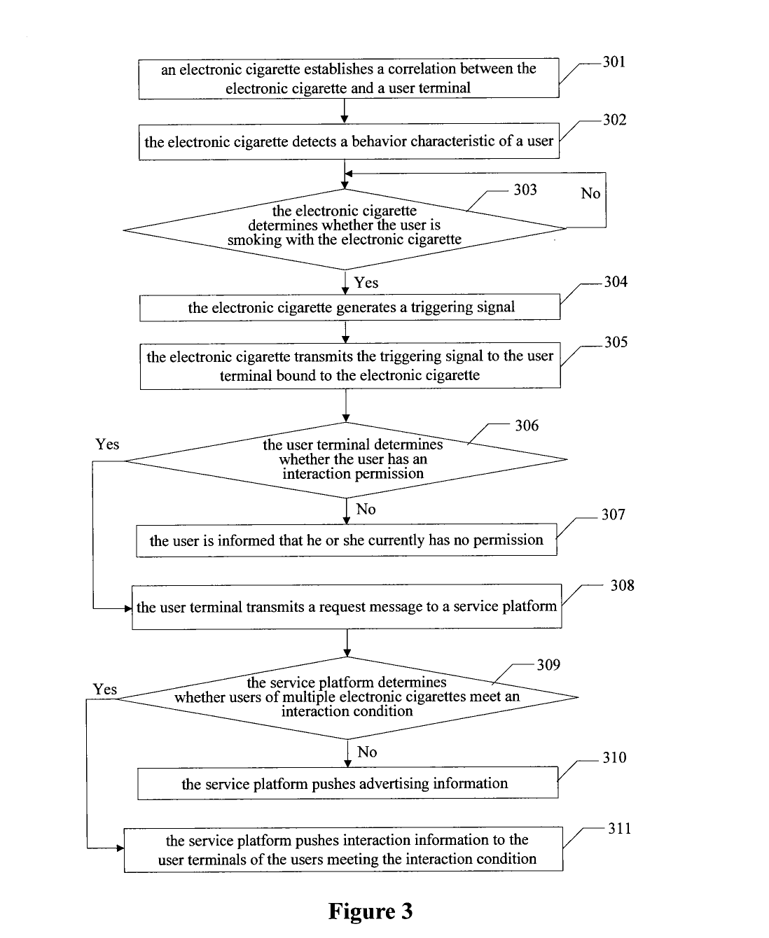

In the above embodiment, the description is given based on an example that the service platform pushes the advertising information and news information. A data communication method according to an embodiment of the present application is described in detail in the following. Reference is made to FIG. 3. A data communication method according to yet another embodiment of the present application includes steps 301 to 311.

In step 301, a correlation between an electronic cigarette and a user terminal is established by the electronic cigarette.

In the embodiment, a user may bind his or her electronic cigarette to his or her user terminal. Particularly, the correlation between the electronic cigarette and the user terminal may be established by the electronic cigarette through a Bluetooth connection, a WIFI connection, an infrared connection or an NFC connection.

The user terminal in the embodiment may be a mobile phone, a personal computer, a laptop, a tablet computer, or other types of terminals, which is not limited in detail here.

In step 302, a behavior characteristic of the user is detected by the electronic cigarette.

In the embodiment, the behavior characteristic of the user may be detected by the electronic cigarette, to analyze a current behavior of the user, for example, the user is smoking, the user is going to smoke, or the user turns off the electronic cigarette, which is not limited in detail here.

In step 303, the electronic cigarette determines whether the user is smoking with the electronic cigarette; if the user is smoking with the electronic cigarette, step 304 is to be performed; or if the user is not smoking with the electronic cigarette, step 303 is to be repeated.

In the embodiment, after detecting the behavior characteristic of the user, the electronic cigarette may determine whether the user is smoking with the electronic cigarette; if the user is smoking with the electronic cigarette, step 304 is to be performed; or if the user is not smoking with the electronic cigarette, the determination is repeated.

It should be noted that whether the user is smoking with the electronic cigarette may be determined by the electronic cigarette in many manners. For example, the determination may be made based on an operating condition of an atomizer assembly in the electronic cigarette, and when the atomizer assembly operates, it may be determined that the user is smoking with the electronic cigarette.

Alternatively, the determination may be made based on an operating condition of a sensor in the electronic cigarette, and when the sensor operates, it may be determined that the user is smoking with the electronic cigarette.

Alternatively, the determination may be made based on a consumption rate of a battery in the electronic cigarette, and when the battery consumption rate is larger than a threshold, it may be determined that the user is smoking with the electronic cigarette.

The sensor in the embodiment may be an airflow sensitive switch or a key switch, or other types of switches, which is not limited in detail here. The key switch may be a tact switch, a sensitive switch or other types of switches, which is neither limited in detail here.

It should be understood that, whether the user is smoking with the electronic cigarette may be determined by the electronic cigarette in many other manners in practice, which are not limited in detail here.

In step 304, a triggering signal is generated by the electronic cigarette.

If the electronic cigarette detects that the user is smoking with the electronic cigarette, it is determined that the behavior characteristic of the user meets a reporting condition, and the triggering signal may be generated by the electronic cigarette. The triggering signal is for indicating that the user is smoking with the electronic cigarette.

Particularly, the sensor in the electronic cigarette generates a pulse signal and transmits the pulse signal to a processor in the electronic cigarette; and

the triggering signal is generated by the processor in the electronic cigarette based on the pulse signal, where the triggering signal is for indicating that the user is smoking with the electronic cigarette.

In step 305, the triggering signal is transmitted by the electronic cigarette to the user terminal bound to the electronic cigarette.

After generating the triggering signal, the electronic cigarette may transmit the triggering signal to a user terminal which is bound to the electronic cigarette in advance.

In step 306, the user terminal determines whether the user has an interaction permission; if the user has the interaction permission, step 308 is to be performed; or if the user does not have the interaction permission, step 307 is to be performed.

In the present embodiment, on reception of the triggering signal from the electronic cigarette, the user platform may analyze the triggering signal to obtain an analysis result. The analysis procedure may include: determining whether the user has the interaction permission; determining that the analysis result is that a transmission is permitted if the user has the interaction permission; or determining that the analysis result is that a transmission is not permitted if the user does not have the interaction permission.

Particularly, the user terminal may determine whether a smoking frequency of the user reaches a preset value; if the smoking frequency of the user reaches the preset value, it indicates that the user is an active user of the electronic cigarette and the user is determined as having the interaction permission; or if the smoking frequency of the user does not reach the preset value, it indicates that the user is a test user or an inactive user and the user is determined as having no interaction permission.

It should be understood that in addition to based on the smoking frequency of the user, whether the user has the interaction permission may be determined by the user terminal in other manners in practice, such as based on a frequency in which the user replaces cigarette liquid, which are not limited in detail here as long as the active user of the electronic cigarette has the interaction permission while the inactive user has no interaction permission.

It should be noted that the smoking frequency of the user, the frequency in which the user replaces the cigarette liquid and the like in the embodiment are all smoking parameters, and these smoking parameters may be synchronized into the user terminal in real time or periodically after the electronic cigarette is bound to the user terminal.

In step 307, the user is informed that he or she currently has no permission.

In the embodiment, if the analysis result is that the transmission is not permitted, the user may be informed that he or she currently has no permission. The user may be further informed how to obtain the interaction permission, which is not limited in detail here.

In step 308, a request message is transmitted to a service platform by the user terminal.

In the embodiment, if the analysis result is that the transmission is permitted, the request message may be generated and the generated request message is transmitted to the service platform. The request message is used to request the service platform to transmit corresponding information to the user terminal.

Particularly, the request message may be transmitted to the service platform by the user terminal via a mobile communication network, a WIFI network, or other types of communication networks.

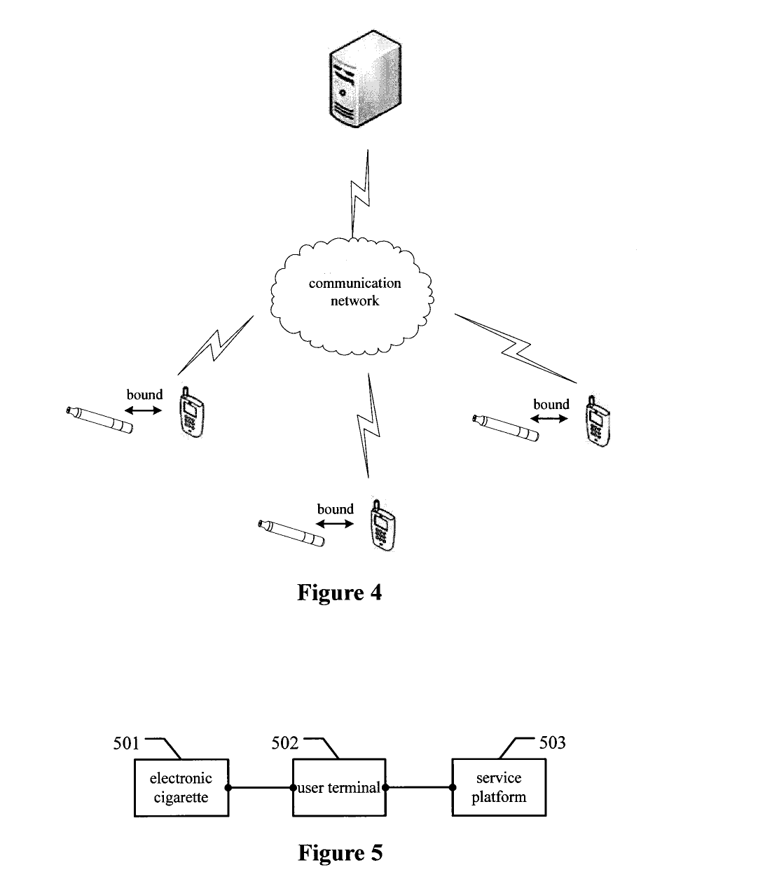

A data communication framework according to the embodiment is shown in FIG. 4. The electronic cigarette is bound to the user terminal. The user terminal is connected to the service platform via the communication network. One service platform may serve multiple electronic cigarettes and multiple user terminals.

In step 309, the service platform determines whether users of multiple electronic cigarettes meet an interaction condition; if the users of the multiple electronic cigarettes meet the interaction condition, step 311 is to be performed; or if the users of the multiple electronic cigarettes do not meet the interaction condition, step 310 is to be performed.

In the embodiment, the service platform may determine, on reception of request messages of multiple user terminals, whether the users of the user terminals meet the interaction condition; if the users of the user terminals meet the interaction condition, step 311 is to be performed; or if the users of the user terminals do not meet the interaction condition, step 310 is to be performed.

To facilitate interaction among users, the service platform may determine whether distances between the users of the multiple user terminals are smaller than a preset distance; if the distances between the users of the multiple user terminals are smaller than the preset distance, it indicates that the users are close to each other, and the interaction among the users may be facilitated.

It should be understood that in addition to based on the distances between users, other manners may be adopted to determine whether the users meet the interaction condition in practice, such as based on determining whether the users use the same type of electronic cigarette or the same type of cigarette liquid, which is not limited in detail here as long as the users with common properties meet the interaction condition.

In step 310, advertising information is pushed by the service platform to the user terminals.

If the users do not meet the interaction condition, advertising information and other types of information may be pushed to the user terminals by the service platform directly, which is not limited in detail here.

In step 311, interaction information is pushed by the service platform to the user terminals.

If the users meet the interaction condition, interaction information may be pushed to the user terminals by the service platform, so that each user interacts with other users.

In the embodiment, step 309 and step 310 are optional. In practice, the service platform may push interaction information to all users without performing the determination, so that each user can interact with other users.

It should be noted that in the embodiment, if an APP program corresponding to the electronic cigarette is installed on the user terminal, information may be pushed to the APP program by the service platform and the information is presented to the user by the APP program; or if the APP program is not installed on the user terminal, the information may be pushed by the service platform to other programs (for example, a browser or an instant messaging service) originally installed on the user terminal and the information may be presented by these programs, which is not limited in detail here.

In the embodiment, when the behavior characteristic of the user meets the reporting condition, the triggering signal may be transmitted by the electronic cigarette to the user terminal for analysis, the request message may be transmitted by the user terminal to the service platform based on the analysis result, and the corresponding information may be pushed to the user terminal by the service platform according to the request message. Since different information may be pushed by the service platform according to different request messages, the content that the user may obtain is not limited to his or her smoking situation, and the user may obtain more contents from the service platform via the user terminal. Therefore, the interaction of more kinds of information can be realized and the user experience can be enhanced.

Furthermore, on reception of the triggering signal from the electronic cigarette, the user terminal may detect the interaction permission of the user. The information pushed by the service platform can be received only by a user who has the interaction permission, thereby reducing the burden on the service platform.

Furthermore, the interaction information may be pushed by the service platform to the user terminals of the users with common properties, so that multiple users can interact with each other, thereby further enhancing the user experience.

The data communication methods according to the embodiments of the present application are described above. A data communication system according to an embodiment of the present application is described in detail in the following. Reference is made to FIG. 5. A data communication system according to the embodiment of the present application includes: an electronic cigarette 501, a user terminal 502 and a service platform 503.

The electronic cigarette 501 is used to, detect a behavior characteristic of a user, generate a triggering signal if the behavior characteristic of the user meets a reporting condition, and transmit the triggering signal to the user terminal 502 bound to the electronic cigarette 501. The triggering signal is for indicating a current behavior of the user

The user terminal 502 is used to analyze the triggering signal to obtain an analysis result and transmit a request massage to the service platform 503 based on the analysis result.

The service platform 503 is used to push corresponding information to the user terminal 502 according to the request message.

In the embodiment, the correlation between the electronic cigarette 501 and the user terminal 502 may be established by the electronic cigarette 501 through a Bluetooth connection, a WIFI connection, an infrared connection or an NFC connection.

In the embodiment, the electronic cigarette 501 at least includes a sensor and a processor.

The sensor generates a pulse signal when the user is smoking and transmits the pulse signal to the processor in the electronic cigarette 501.

The processor in the electronic cigarette 501 generates a triggering signal based on the pulse signal, where the triggering signal is for indicating that the user is smoking with the electronic cigarette.

In the embodiment, the sensor may be an airflow sensitive switch, a key switch, or other types of switches, which is not limited in detail here. The key switch may be a tact switch, a sensitive switch or other types of switches, which is neither limited in detail here.

In the embodiment, the user terminal 502 is used to, determine whether the user has an interaction permission based on the triggering signal, determine that the analysis result is that a transmission is permitted if the user has the interaction permission, and transmit a request message to the service platform 503 if the analysis result is that the transmission is permitted.

The user terminal 502 in the embodiment may be a mobile phone, a personal computer, a laptop, a tablet computer, or other types of terminals, which is not limited in detail here.

For an easier understanding, a data communication system according to an embodiment of the present application is described based on a particular application scenario in the following.

In the embodiment, a user may bind his or her electronic cigarette 501 to his or her user terminal 502. Particularly, the correlation between the electronic cigarette 501 and the user terminal 502 is established by the electronic cigarette 501 through a Bluetooth connection, a WIFI connection, an infrared connection or an NFC connection.

The user terminal 502 in the embodiment may be a mobile phone, a personal computer, a laptop, a tablet computer, or other types of terminals, which is not limited in detail here.

A behavior characteristic of the user may be detected by the electronic cigarette 501, to analyze a current behavior of the user, for example, the user is smoking, the user is going to smoke, or the user turns off the electronic cigarette, which is not limited in detail here.

After detecting the behavior characteristic of the user, the electronic cigarette 501 may determine whether the user is smoking with the electronic cigarette.

It should be noted that, whether the user is smoking with the electronic cigarette 501 may be determined by the electronic cigarette 501 in many manners. For example, the determination may be made based on an operating condition of an atomizer assembly in the electronic cigarette 501, and when the atomizer assembly operates, it may be determined that the user is smoking with the electronic cigarette 501.

Alternatively, the determination may be made based on an operating condition of a sensor in the electronic cigarette 501, and when the sensor operates, it may be determined that the user is smoking with the electronic cigarette 501.

Alternatively, the determination may be made based on a consumption rate of a battery in the electronic cigarette 501, and when the battery consumption rate is larger than a threshold, it may be determined that the user is smoking with the electronic cigarette 501.

The sensor in the embodiment may be an airflow sensitive switch or a key switch, or other types of switches, which is not limited in detail here. The key switch may be a tact switch, a sensitive switch or other types of switches, which is neither limited in detail here.

It should be understood that whether the user is smoking with the electronic cigarette may be determined by the electronic cigarette 501 in many other manners in practice, which are not limited in detail here.

If the electronic cigarette 501 detects that the user is smoking with the electronic cigarette 501, it is determined that the behavior characteristic of the user meets a reporting condition, and the electronic cigarette 501 may generate a triggering signal. The triggering signal is for indicating that the user is smoking with the electronic cigarette 501.

Particularly, the sensor in the electronic cigarette 501 generates a pulse signal and transmits the pulse signal to a processor in the electronic cigarette 501; and

the triggering signal is generated by the processor in the electronic cigarette 501 based on the pulse signal, where the triggering signal is for indicating that the user is smoking with the electronic cigarette 501.

After generating the triggering signal, the electronic cigarette 501 may transmit the triggering signal to the user terminal 502 which is bound to the electronic cigarette 501 in advance.

In the embodiment, on reception of the triggering signal from the electronic cigarette 501, the user terminal 502 may analyze the triggering signal to obtain an analysis result. The analysis procedure may include: determining whether the user has an interaction permission; determining that the analysis result is that a transmission is permitted if the user has the interaction permission; or determining that the analysis result is that a transmission is not permitted if the user does not have the interaction permission.

Particularly, it may be determined by the user terminal 502 whether a smoking frequency of the user reaches a preset value; if the smoking frequency of the user reaches the preset value, it indicates that the user is an active user of the electronic cigarette and the user is determined as having the interaction permission; or if the smoking frequency of the user does not reach the preset value, it indicates that the user is a test user or an inactive user and the user is determined as having no interaction permission.

It should be understood that, in addition to based on the smoking frequency of the user, whether the user has the interaction permission may be determined by the user terminal 502 in other manners in practice, such as based on a frequency in which the user replaces cigarette liquid, which are not limited in detail here as long as the active user of the electronic cigarette has the interaction permission while the inactive user has no interaction permission.

It should be noted that the smoking frequency of the user, the frequency in which the user replaces the cigarette liquid and the like in the embodiment are all smoking parameters, and these smoking parameters may be synchronized into the user terminal 502 in real time or periodically after the electronic cigarette 501 is bound to the user terminal 502.

In the embodiment, if the user terminal 502 determines that the analysis result is that the transmission is not permitted, the user may be informed that he or she currently has no permission. The user may be further informed how to obtain the interaction permission, which is not limited in detail here.

In the embodiment, if the user terminal 502 determines that the analysis result is that the transmission is permitted, a request message may be generated and transmitted to a service platform 503. The request message is used to request the service platform 503 to transmit corresponding information to the user terminal 502.

Particularly, the request message may be transmitted to the service platform 503 by the user terminal 502 via a mobile communication network, a WIFI network, or other types of communication networks.

In the embodiment, the service platform 503 may determine, on reception of request messages of multiple user terminals, whether users of the user terminals meet an interaction condition.

To facilitate interaction among users, it may be determined by the service platform 503 whether distances between the users of the multiple user terminals are smaller than a preset distance; if the distances between the users of the multiple user terminals are smaller than the preset distance, it indicates that the users are close to each other, and the interaction among the users may be facilitated.

It should be understood that in addition to based on the distances between users, other manners may be adopted to determine whether the users meet the interaction condition in practice, such as based on determining whether the users use the same type of electronic cigarette or the same type of cigarette liquid, which is not limited in detail here as long as the users with common properties meet the interaction condition.

If the users do not meet the interaction condition, advertising information or other types of information may be pushed to the user terminals 502 by the service platform 503 directly, which is not limited in detail here.

If the users meet the interaction condition, interaction information may be pushed to the user terminals 502 by the service platform 503, so that each user interacts with other users.

It should be noted that in the embodiment, if an APP program corresponding to the electronic cigarette is installed on the user terminal 502, information may be pushed to the APP program by the service platform 503 and the information is presented to the user by the APP program; or if the APP program is not installed on user terminal 502, the information may be pushed by the service platform 503 to other programs (for example, a browser or an instant messaging service) originally installed on the user terminal 502 and the information may be presented by these programs, which is not limited in detail here.

In the embodiment, when the behavior characteristic of the user meets the reporting condition, the triggering signal may be transmitted by the electronic cigarette 501 to the user terminal 502 bound to the electronic cigarette 501. The triggering signal may be analyzed by the user terminal 502 to obtain the analysis result, and the request message may be transmitted by the user terminal 502 to the service platform 503 based on the analysis result. Corresponding information may be pushed by the service platform 503 to the user terminal 502 according to the request message. Since different information may be pushed by the service platform 503 according to different request messages, the content that the user may obtain is not limited to his or her smoking situation, and the user may obtain more contents from the service platform 503 via the user terminal 502. Therefore, the interaction of more kinds of information can be realized and the user experience can be enhanced.

Furthermore, on reception of the triggering signal from the electronic cigarette 501, the user terminal 502 may detect the interaction permission of the user. The information pushed by the service platform 503 may be received only by a user who has the interaction permission, thereby reducing the burden on the service platform 503.

Furthermore, the interaction information may be pushed by the service platform 503 to the user terminals 502 of users with common properties, so that multiple users can interact with each other, thereby further enhancing the user experience.

1. A data communication method, comprising:
detecting, by an electronic cigarette, a behavior characteristic of a user;
generating, by the electronic cigarette, a triggering signal if the behavior characteristic of the user meets a reporting condition, wherein the triggering signal indicates a current behavior of the user;
transmitting, by the electronic cigarette, the triggering signal to a user terminal bound to the electronic cigarette;
analyzing, by the user terminal, the triggering signal to obtain an analysis result;
transmitting, by the user terminal, a request massage to a service platform based on the analysis result; and
pushing, by the service platform, corresponding information to the user terminal according to the request massage.

2. The method according to claim 1, further comprising:
establishing, by the electronic cigarette, a correlation between the electronic cigarette and the user terminal.

3. The method according to claim 2, wherein the correlation between the electronic cigarette and the user terminal is established by the electronic cigarette through a Bluetooth connection, a WIFI connection, an infrared connection or an NFC connection.

4. The method according to claim 1, further comprising:
determining, by the electronic cigarette, whether the user is smoking with the electronic cigarette; and
determining that the behavior characteristic of the user meets the reporting condition, if the user is smoking with the electronic cigarette.

5. The method according to claim 4, wherein the generating, by the electronic cigarette, the triggering signal comprises:
generating a pulse signal and transmitting the pulse signal to a processor in the electronic cigarette, by a sensor in the electronic cigarette; and
generating, by the processor in the electronic cigarette, the triggering signal based on the pulse signal, wherein the triggering signal indicates that the user is smoking with the electronic cigarette.

6. The method according to claim 5, wherein the sensor is an airflow sensitive switch or a key switch; and
wherein the key switch is a tact switch or a sensitive switch.

7. The method according to claim 1, wherein the analyzing, by the user terminal, the triggering signal to obtain an analysis result comprises:
determining, by the user terminal, whether the user has an interaction permission based on the triggering signal, and determining that the analysis result is that a transmission is permitted if the user has the interaction permission; and
the transmitting, by the user terminal, a request massage to a service platform based on the analysis result comprises:
transmitting, by the user terminal, the request massage to the service platform if the analysis result is that the transmission is permitted.

8. The method according to claim 7, wherein the determining, by the user terminal, whether the user has an interaction permission based on the triggering signal comprises:
determining, by the user terminal, whether a smoking frequency of the user reaches a preset value based on the triggering signal, and determining that the user has the interaction permission if the smoking frequency of the user reaches the preset value.

9. The method according to claim 4, wherein the pushing, by the service platform, the corresponding information to the user terminal according to the request massage comprises:
pushing, by the service platform, advertising information or news contents to the user terminal.

10. The method according to claim 4, wherein the pushing, by the service platform, the corresponding information to the user terminal according to the request massage comprises:
determining whether users of a plurality of user terminals meet an interaction condition, by the service platform on reception of request massages of the plurality of user terminals; and
pushing, by the service platform, interaction information to user terminals of users meeting the interaction condition, wherein the users meeting the interaction condition interact with each other.

11. The method according to claim 10, wherein the determining whether users of a plurality of user terminals meet an interaction condition, by the service platform comprises:
determining, by the service platform, whether distances between the users of the plurality of user terminals are smaller than a preset distance; and
determining that the users of the plurality of user terminals meet the interaction condition, if the distances between the users of the plurality of user terminals are smaller than the preset distance.

12. The method according to claim 1, wherein the user terminal is a mobile phone, a personal computer, a laptop or a tablet computer.

13. A data communication system, comprising:
an electronic cigarette, a user terminal and a service platform;
wherein the electronic cigarette is configured to, detect a behavior characteristic of a user, generate a triggering signal if the behavior characteristic of the user meets a reporting condition, and transmit the triggering signal to the user terminal bound to the electronic cigarette, the triggering signal indicating a current behavior of the user;
the user terminal is configured to analyze the triggering signal to obtain an analysis result and transmit a request massage to the service platform based on the analysis result; and
the service platform is configured to push corresponding information to the user terminal according to the request massage.

14. The data communication system according to claim 13, wherein a correlation between the electronic cigarette and the user terminal is established by the electronic cigarette through a Bluetooth connection, a WIFI connection, an infrared connection or an NFC connection.

15. The data communication system according to claim 13, wherein the electronic cigarette at least comprises a sensor and a processor;
wherein the sensor is configured to generate a pulse signal and transmit the pulse signal to the processor in the electronic cigarette, when the user is smoking; and
the processor in the electronic cigarette is configured to generate the triggering signal based on the pulse signal, the triggering signal indicating that the user is smoking with the electronic cigarette.

16. The data communication system according to claim 15, wherein the sensor is an airflow sensitive switch or a key switch; and
wherein the key switch is a tact switch or a sensitive switch.

17. The data communication system according to claim 13, wherein the user terminal is configured to, determine whether the user has an interaction permission based on the triggering signal, determine that the analysis result is that a transmission is permitted if the user has the interaction permission, and transmit the request message to the service platform if the analysis result is that the transmission is permitted.

18. The data communication system according to claim 13, wherein the user terminal is a mobile phone, a personal computer, a laptop or a tablet computer.
